(19) United States
(12) Patent Application Publication
(10) Pub. No.: US 2024/0071118 A1
(43) Pub. Date: Feb. 29, 2024

(54) INTELLIGENT SHAPE PREDICTION AND AUTOCOMPLETION FOR DIGITAL INK

(71) Applicant: Microsoft Technology Licensing, LLC, Redmond, WA (US)

(72) Inventors: Ava Jane SCHREIBER, Seattle, WA (US); Christian Mendel CANTON, Bellevue, WA (US); Erica Simone MARTIN, Mountain View, CA (US)

(73) Assignee: Microsoft Technology Licensing, LLC, Redmond, WA (US)

(21) Appl. No.: 17/900,677

(22) Filed: Aug. 31, 2022

(51) Int. Cl. G06V 30/32; G06F 3/0354; G06F 3/041; G06V 10/774

(52) U.S. Cl. CPC G06V 30/347; G06F 3/03545; G06F 3/0416; G06V 10/7747; G06V 30/387; G06F 2203/04101

(57) ABSTRACT

Systems and methods for shape prediction for digital inking applications include training a shape prediction model to predict complete shapes based digital ink data defining unfinished shapes. During use, digital ink data representing an unfinished shape is input to a digital inking application and displayed in a canvas area of the application. The digital ink data is also provided to the shape prediction model as input. The shape prediction model generates a shape prediction based on the digital ink data. The shape prediction is displayed in the canvas area. When a second input is received indicating acceptance of the shape prediction, the digital ink forming the unfinished shape is replaced with digital ink forming a predicted complete shape.

### BACKGROUND

Computers are regularly used for a variety of purposes throughout the world. As computers have become commonplace, computer manufacturers have continuously sought to make them more accessible and user-friendly. One such effort has been the development of natural input methods, such as handwriting, for providing input to computing devices. The use of handwriting as input to a computing device has been enabled through the use of “electronic ink” or “digital ink. Digital ink is implemented by capturing a user's interactions (e.g., hand movements) with an input device, such as a digitizer, pointing device or the like, and converting the interactions to digital ink strokes which can be rendered and displayed on a display device. The use of handwriting input is particularly useful when the use of a keyboard and mouse would be inconvenient or inappropriate, such as when the computing device has a small form factor (e.g., mobile phone or tablet), when a user is moving, in quiet settings, and the like.

In addition to handwriting, the use of digital ink enables users to create drawings which can be rendered and displayed on a display device. However, since the drawings are produced by hand, e.g., by sketching out shapes and lines with a user input device, it may be difficult for a user to produce drawings with a satisfactory degree of precision. To address this difficulty, previously known digital ink implementations have provided shape recognition functionality in which digital ink strokes are checked to determine if they resemble a shape and then providing a beautified version of the shape as an option that may be entered as input to the system (e.g., by replacing the previously entered strokes). However, these previously known implementations are typically only capable of recognizing completed shapes and therefore only present beautified shapes to the user after the shapes has been completely drawn.

In addition, the incorporation of recognized shapes into applications often requires interaction with user interface controls, selection of options, and the like before the shape can be added to the application. This can be time consuming and may require the user to leave the drawing mode in order to access the user interface, such as menus, selectable options, and the like, within the inking application to activate shape recognition and incorporate finished, beautified shapes into the application.

What is needed are systems and methods for digital ink applications that enable shapes to be predicted as they are being drawn so that beatified shapes may be presented to the user for input before the shape is completed and without requiring significant input and/or action from a user.

### SUMMARY

In one general aspect, the instant disclosure presents a data processing device having a processor and a memory in communication with the processor. The memory includes executable instructions that, when executed by the processor, cause the data processing device to perform functions. The functions include receiving a first input via a user input device corresponding to a first portion of a digital ink stroke; displaying the first portion of the digital ink stroke in a digital ink display area of an application on a display device, the first portion forming an unfinished shape; processing the first portion of the digital ink stroke using a shape prediction model to determine a first prediction of a complete shape being drawn in the digital ink display area; displaying the first prediction of the complete shape in the digital ink display area of the application proximate the unfinished shape; receiving a second input via the user input device indicating acceptance of the complete shape; and in response to receiving the second input, replacing the digital ink forming the unfinished shape with digital ink forming the complete shape.

In yet another general aspect, the instant disclosure presents a method of processing digital ink in an application. The method includes training a shape prediction model to predict complete shapes based digital ink data defining unfinished shapes; receiving first digital ink data via a user input device defining a portion of a digital ink stroke; displaying the first digital ink data as digital ink in a digital ink display area of an application on a display device, the first digital ink data forming an unfinished shape; processing the first digital ink data using the shape prediction model to determine a first prediction of a complete shape being drawn in the digital ink display area; displaying the first prediction of the complete shape in the digital ink display area of the application proximate the unfinished shape; receiving a second input via the user input device indicating acceptance of the complete shape; and in response to receiving the second input, replacing the digital ink forming the unfinished shape with digital ink forming the complete shape.

In a further general aspect, the instant application describes a non-transitory computer readable medium on which are stored instructions that, when executed, cause a programmable device to perform functions of receiving first digital ink data via a user input device defining a portion of a digital ink stroke; displaying the first digital ink data as digital ink in a digital ink display area of an application on a display device, the first digital ink data forming an unfinished shape; processing the first digital ink data using a shape prediction model to determine a first prediction of a complete shape being drawn in the digital ink display area; displaying the first prediction of the complete shape in the digital ink display area of the application proximate the unfinished shape; receiving a second input via the user input device indicating acceptance of the complete shape; and in response to receiving the second input, replacing the digital ink forming the unfinished shape with digital ink forming the complete shape.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example computing device including a digital inking application with a shape prediction component in accordance with this disclosure.

FIG. 3 shows example implementations of a digital inking application and a shape prediction component such as depicted in FIG. 2.

FIGS. 4A-4D show examples different shape predictions that may be generated and displayed based on different digital ink stroke configurations.

FIG. 5 shows a flowchart of an example method of providing shape predictions for digital ink applications.

FIG. 6 is a block diagram showing an example software architecture, various portions of which may be used in conjunction with various hardware architectures herein described, which may implement any of the described features.

FIG. 7 is a block diagram showing components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

As discussed above, the use of digital ink has enabled handwriting and hand movements to be used to provide input to various types of applications. This in turn has enables users to create drawings with various shapes which can be rendered and displayed on a display device. However, it is difficult for a user to produce drawings with a satisfactory degree of precision when sketching out shapes and lines by hand. Previously known systems and methods have attempted to solve this problem using shape recognition features which are configured to recognize shapes drawn with digital ink and replace the drawn shapes with beautified shapes. However, these previously known systems and methods are typically only capable of recognizing completed shapes, so shape recognition and replacement only occurs after the shapes have been completely drawn. In addition, the shape recognition and/or shape replacement with beautified shapes would typically require user interaction with various user interface controls which may take time and may require the user to leave the drawing mode which can interrupt the flow of work.

To address these technical problems and more, in an example, this description provides technical solutions in the form of systems and methods for implementing shape prediction and autocompletion for digital inking applications. The systems and methods described herein enable the user's ink strokes to be analyzed to predict shapes to the user before the drawing has been completed. The beautified shape may then be automatically converted to digital ink strokes in response to a basic input or action from the user. The systems and methods for shape prediction and autocompletion described herein allow users to stay in the flow of work and remain focused on the task at hand with minimal distractions and inefficiencies associated with previously known methods of shape recognition and replacement and without requiring interaction with various user interface elements (e.g., menus, tools, buttons, moving to different locations within a canvas).

A technical benefit of the color recommendation service described herein is that digital ink drawings may be created with increased speed, precision, and confidence due to the shape prediction and autocompletion features described herein. This in turn can improve the quality of documents and/or content created with digital ink while at the same time improving the user experience.

As used herein, “digital ink” refers to the capture and display of electronic information derived from a user's hand movements imparted to a user input device, such as movement of a stylus, pen or finger with respect to a digitizer, movement of a pointing device on a display screen by a mouse, trackball, joystick, etc., or similar type of input device. Digital ink is captured as a sequence or set of digital ink strokes with properties. Digital ink strokes in turn are comprised of a sequence of points. The strokes may have been drawn or collected at the same time or may have been drawn or collected at independent times and locations and for independent reasons. The points may be represented using a variety of known techniques including Cartesian coordinates (X, Y), polar coordinates (r, Θ), and other techniques as known in the art. In embodiments, a digital ink strokes include a beginning point, an end point, and intermediate points. Beginning points and end points may be indicated based on input received from the user input device. For example, a beginning point may be indicated as the point where a stylus is brought into contact with a digitizer (e.g., pen down) or when a button on a pointing device, such as a mouse, is held down, and the end point may be indicated as the point where a stylus is moved away from the digitizer (e.g., pen up) or when the button on the point device is released. Intermediate points correspond to points along the path of travel of the user input device between the beginning point and end point.

Digital ink strokes may include representations of properties including pressure, angle, speed, color, stylus size, and ink opacity. Digital ink may further include other properties including the order of how ink was deposited on a page (a raster pattern of left to right then down for most western languages), a time stamp (indicating when the ink was deposited), an indication of the author of the ink, and the originating device (at least one of an identification of a machine upon which the ink was drawn or an identification of the pen used to deposit the ink) among other information.

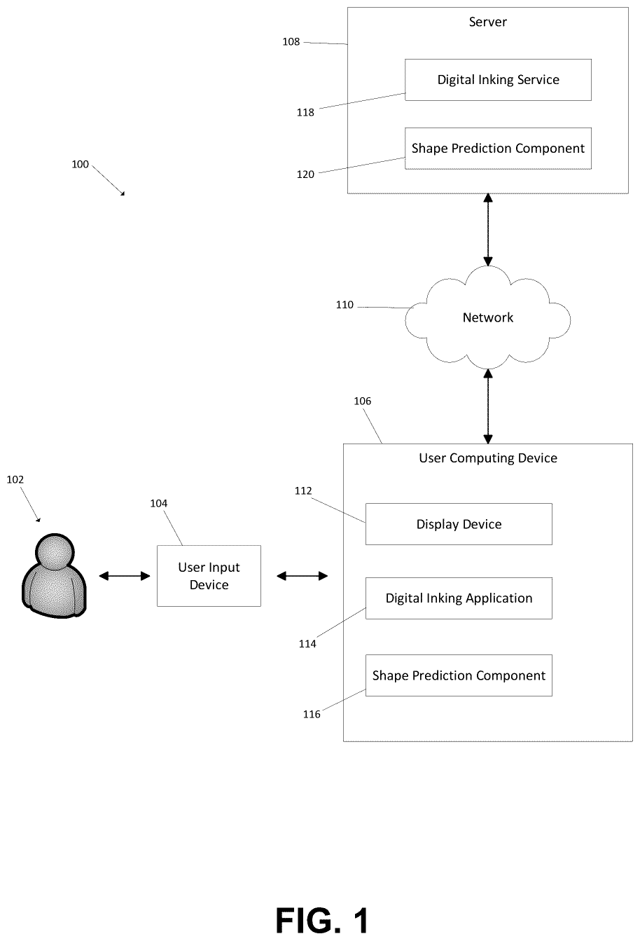

FIG. 1 illustrates an example system 100, upon which aspects of this disclosure may be implemented. The system 100 includes a user computing device 106 and a user input device 104. Non-limiting examples of the user computing device 106 include a laptop computer, a desktop computer, a tablet computer, a mobile telephone, a personal digital assistant (PDA), a mobile email device, or another electronic device configured to perform digital inking or digital ink editing. The computing device 106 has at least one display device 112 for displaying images, text, and video. The display device 112 may use LCD, plasma, LED, iOLED, CRT, or any other appropriate technology. In embodiments, the display device may comprise a touch screen or touch sensitive device, as known to those of ordinary skill in the art. The user input device 104 comprises a device that is configured to provide electronic input to the computing device 106 based on the manipulation of the user input device 104 by a user 102. The user input device 104 may comprise a digitizer and an input tool, such as a stylus, pen, or finger. The user input device 104 may also comprise a pointing device such as a mouse, trackball, joystick, etc., or similar type of tool or object. The user input device 104 is configured to provide input to the digital inking application 114 indicative of the movement imparted to the user input device by the user 102.

The digital inking application 114 is configured to receive the input from the user input device 104 and convert the input into digital ink strokes and render and display the digital ink strokes in a digital ink display area, or canvas, on the display device. In some embodiments, the digital inking application 114 is a stand-alone application executed by the computing device 106 to provide local digital inking and digital ink editing functionality for the computing device 105. In other embodiments, the digital inking application 114 may access or otherwise communicate with a digital inking service 118 provided by a server 108, which may provide one or more hosted services. In this embodiment, the user computing device 106 is connected to a network 110 to communicate with the server 108. The network 110 can include wired networks, wireless networks, or a combination thereof that enable communications between the various entities in the system 100. In some configurations, the communication network 110 includes cable networks, the Internet, local area networks (LANs), wide area networks (WAN), mobile telephone networks (MTNs), and other types of networks, possibly used in conjunction with one another, to facilitate communication between the user computing device 106 and the server 108.

In embodiments where the digital inking application 114 communicates with the digital inking service 118, the digital inking application 114 installed on the user computing device 106 may be a general-purpose browser application configured to access various services and content over the network 110, including the digital inking service 118. Alternatively, in this embodiment, the digital inking application 114 installed on the user computing device 106 may be a dedicated application configured to access the digital inking service 118.

The system 100 also includes a shape prediction component 116, 120 that enables shape prediction and autocompletion for digital inking applications, such as digital inking application 114 and digital inking service 118. In embodiments, the shape prediction component 116, 120 may be integrated into digital inking applications. For example, the shape prediction component 116 may be integrated into the digital inking application 114 of the user computing device 106, and the shape prediction component 120 may be integrated into the digital inking service 118 on the server 108. In some embodiments, the shape prediction component 116, 120 may be provided as a standalone application installed locally on the user computing device 106 and server 108. on a machine, such as the shape prediction component 116 on the user computing device 106 and/or the shape prediction component 120 on the server 108. In these embodiments, the shape prediction components 116, 120 may have an application programming interface (API) that enables external applications to access the shape prediction functionality. Digital inking application 114 on user computing device may access the shape prediction component 116 if locally installed on the user computing device 106 or may access the shape prediction component 120 if provided as a service on server 108.

Although the system 100 shows only a single computing device 106 and server 108, the system 100 may include additional or fewer components and may combine components and divide one or more components into additional components. For example, the system 100 may include any number of user computing devices 106 and/or networks 125 of different types. Various intermediary devices may exist between a user computing device 106 and the server 108. Also, in some embodiments, multiple servers 108 may be used to provide the digital inking service 130 and/or shape prediction component 120, such as within a cloud computing environment.

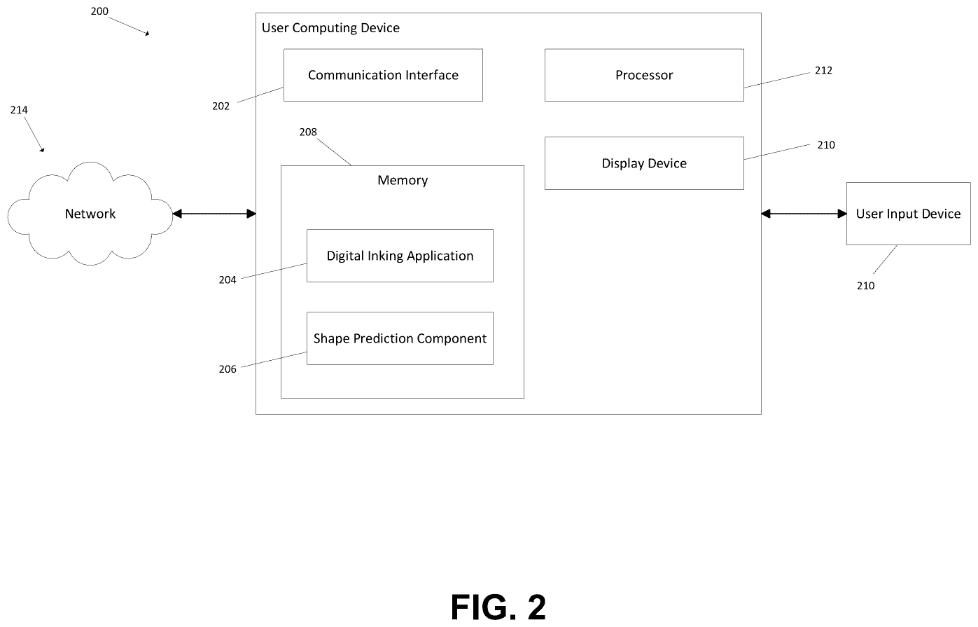

FIG. 2 shows an example user computing device 200 which may be used to implement the computing device 106 of FIG. 1. The user computing device 200 includes an electronic processor 212, a computer-readable memory 208, and a communication interface 202. The electronic processor 212, memory 208, and communication interface 202 communicate wirelessly, over one or more wired communication channels or busses, or a combination thereof (not illustrated) within the computing device 200. The memory 205 may include non-transitory memory, such as random-access memory, read-only memory, or a combination thereof. The electronic processor 212 may include a microprocessor, a microcontroller, a digital signal processor, or any combination thereof configured to execute instructions stored in the memory 208. The memory 208 may also store data used with and generated by execution of the instructions. The communication interface 202 allows the user computing device 200 to communicate with external networks and devices, including, for example, the network 214. For example, the communication interface 202 may include a wireless transceiver for communicating with the network 214. It should be understood that the user computing device 200 may include additional or fewer components than those illustrated in FIG. 2 and may include components in various configurations. For example, in some embodiments, the user computing device 200 includes a plurality of electronic processors, a plurality of memories, a plurality of communication interfaces, and/or combinations thereof. Also, in some embodiments, the user computing device 200 includes additional input devices, output devices, or a combination thereof.

As shown in FIG. 2, the memory 208 stores a digital inking application 204 and a shape prediction component 206. The digital inking application 204 (as executed by the electronic processor 212) provides a canvas for receiving and displaying digital ink strokes. Digital ink strokes are generated by user input device 210, which may be a stylus, pen, or pointing device (e.g., mouse). Shape prediction component 206 (as executed by the processor) provides shape prediction and autocompletion functionality as described below. In embodiments, digital inking application 204 may be configured to access shape prediction component 120 provided as a service on server 108 for shape prediction functionality. In some embodiments, digital inking application 204 may be configured to access digital inking service 118 provided on server 108. In this case, digital inking application 204 may comprise a browser for accessing the digital ink service 204 and shape prediction component 120 as a web application.

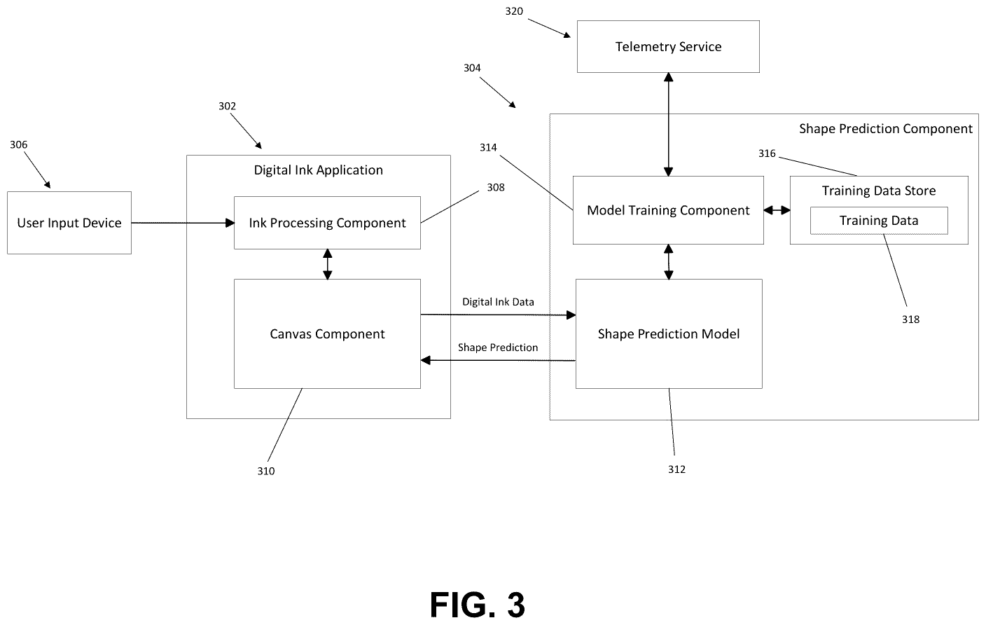

FIG. 3 shows example implementations of a digital inking application 302 and shape prediction component 304. The digital ink application 302 includes at least an ink processing component 308 and a canvas component 310. The ink processing component 308 is configured to receive input from a user input device 306 and process the input into digital ink data and to provide the digital ink data to the canvas component 310. In embodiments, the ink processing component may be configured to perform preprocessing steps on the digital ink data to achieve greater accuracy and to reduce the processing time during the rendering and shape prediction. This preprocessing may include normalizing of the path connecting the beginning point and ending point of a digital ink stroke by applying size normalization and/or methods such as B-spline approximation to smooth the input.

The canvas component 310 is configured to receive the digital ink data and render the digital ink data as digital ink strokes for display in a canvas area of a display screen (e.g., of the display device) and for storage in a memory (not shown). The canvas component 310 is configured to process and display the digital ink in real-time so that the digital ink strokes may be displayed in a manner that simulates the digital ink strokes being drawn on the canvas by the user. The canvas component is also configured to provide the digital ink data to the shape prediction component 304.

The shape prediction component 304 is configured to process the received digital ink data and to generate predictions of completes shapes being drawn in the canvas area. The shape prediction component 304 is configured to process the digital ink data as it is received such that shape predictions are generated in real-time as shapes are being drawn and before the shapes have been completed. In embodiments, shape predictions are based at least in part on partial digital ink strokes. For example, as a user is providing input corresponding to a digital ink stroke, the digital ink data received by the system includes only the beginning point and an initial portion of the points defining the path of the ink stroke from the beginning point. The shape prediction component is configured to generate shape predictions based on the portion of the digital ink stroke that has drawn and before the digital ink stroke has been completed, e.g., before the ending point of the digital ink stroke has been received as input. Shapes drawn by a user may be formed by a single digital ink stroke or multiple ink strokes. The shape prediction component 304 is configured to process the unfinished digital ink stroke currently being drawn on the canvas in conjunction with the digital ink strokes previously drawn on the canvas to generate shape predictions.

Once a shape prediction has been generated, the complete shape indicated by the shape prediction is provided to the canvas component 310 for display on the canvas. In embodiments, the predicted complete shape is provided to the canvas component 310 as digital ink data which may be rendered and displayed on the canvas. The predicted complete shape may be positioned in any suitable location in relation to the digital ink strokes forming the unfinished shape in the canvas area. For example, the predicted complete shape may be displayed overlaid on the unfinished shape, under the unfinished shape, or adjacent the unfinished shape (e.g., to the top, bottom, or to either side). In embodiments, the predicted complete shape has dimensions that correspond substantially to the dimensions of the digital ink strokes forming the unfinished shape in the canvas area. In addition, the predicted complete shape is provided as a beautified version of the shape relative to the digital ink strokes drawn in the canvas area by the user. For example, the beautified shape may be provided with smooth lines, appropriate straight or curved lines, appropriate orientations of sides with respect to each other, consistent curvature, etc., depending on the predicted shape.

In embodiments, predicted complete shapes may be displayed on the canvas in a manner that differentiates the predicted shape from the digital ink strokes previously drawn by the user so that the user may easily identify the predicted shapes. For example, predicted complete shapes may be displayed with a different color, thickness, pattern, and/or the like relative to the digital ink strokes drawn by the user. Additional user interface approaches may also be employed such as identifying the predicted shape using callouts, highlighting, and the like.

Because shape predictions are generated while the user is still providing digital ink for the drawing, the complete shape may be presented to the user before the drawing of the shape has been completed by the user. This has the advantage that a beautified shape may be presented to a user and incorporated into the application without requiring the drawing of the shape to be completed which saves time and increases the efficiency and quality of experience of using the application.

Once the shape prediction has been displayed in the canvas area, the shape prediction may continue to be displayed until either the shape prediction has been accepted, the shape prediction is updated such that a new predicted shape is presented, or the digital ink input from the user indicates that a shape is not currently being drawn on the canvas. In any case, when a shape prediction has been accepted, the canvas component 310 is configured to delete the digital ink strokes entered by the user forming the unfinished shape and replace them with the completed shape from the shape prediction.

Acceptance of a shape prediction may be indicated in any suitable manner. In embodiments, the acceptance of the predicted shape may be indicated by the user ending the digital ink stroke currently being drawn on the canvas. For example, in the case of the user input device being stylus, acceptance of the shape prediction may be indicated by the user lifting the stylus from the digitizer (e.g., pen up). In the case of the input device comprising a mouse, acceptance of the shape prediction may be indicated by releasing the button that was pressed to indicate that the mouse input corresponds to a digital ink stroke. In other embodiment, acceptance of the predicted shape may be indicated by holding the input in place, e.g., not moving the user input device, for a timeout period after which the predicted shape may be incorporated onto the canvas. In any case, accepting the predicted shape in this manner does not require any extra input or action from the user, such as leaving the drawing mode to interact with a user interface control, navigate a menu, select an option, etc.

In embodiments, shape predictions may be dismissed in any suitable manner. For example, shape predictions may be dismissed if not accepted by a user within a predetermined amount of time and/or if a user input is received that has been assigned to indicate dismissal of the shape prediction, such as pressing a button on a user input device or selecting an option via a user interface of the application. As noted above, shape predictions may also be removed automatically by the application when the digital ink data indicates that a shape is not currently being drawn. This may occur, for example, when the digital ink input corresponds to handwriting.

Referring to FIG. 3, the shape prediction component 304 includes a shape prediction model 312 that is configured to receive digital ink data as input from the canvas component 310 and is trained to output shape predictions which are returned to the canvas component 310. The shape prediction model 312 is configured to process the digital ink data to generate the shape predictions as the digital ink data is received, i.e., as the digital ink strokes defined by the digital ink data are being drawn in the canvas area. More specifically, the shape prediction model 312 is configured to predict a complete shape that is most likely being drawn in the canvas area based on the most recently received digital ink data in conjunction in conjunction with previously received digital ink data.

The shape prediction model 312 may be configured to predict the shape that is most likely being drawn in the canvas area from the digital ink data in any suitable manner. In embodiments, the shape prediction model 312 comprises a machine learning (ML) model trained to score candidate shapes based on digital ink input and to provide the candidate shape with the highest score indicating the most likely shape to the canvas component 310 as a shape prediction. To this end, the shape prediction component 304 includes a model training component 314 that is configured to train the shape prediction model 312 using training data 318 stored in a training data store 316 to provide initial and ongoing training for the shape prediction model 312. The training data may include sets of digital ink data representing unfinished shapes correlated with digital ink data representing complete shapes. The training data sets are selected to enable the shape prediction model to learn rules for scoring candidate shapes based on digital ink input. In embodiments, the shape prediction model 312 is trained to score candidate shapes based on the likelihood that the unfinished shape represented by the digital ink input corresponds to the candidate shape. The shape prediction model 312 may implement any suitable machine learning algorithm (MLA) for generating shape predictions, including, for example, decision trees, random decision forests, neural networks, deep learning (for example, convolutional neural networks), support vector machines, regression (for example, support vector regression, Bayesian linear regression, or Gaussian process regression).

In embodiments, training data sets may be derived from telemetry data related to the usage of digital inking applications. The telemetry data includes digital ink data representing digital ink strokes used by users to form shapes in different digital inking applications. The telemetry data may be used to identify sequences, patterns, and shapes of digital ink strokes used by users to form shapes in digital ink as well as the frequency of using different sequences, patterns, and shapes of digital ink strokes to form shapes. The telemetry data may be used to derive training data sets that enable the shape prediction model 312 to learn rules for scoring candidate shapes based on digital ink input. In embodiments, model training component 314 may comprise a ML model trained to generate training data sets from telemetry data to be used to train the shape prediction model 312.

In embodiments, digital ink telemetry data may be tracked and collected by a telemetry service 320. Telemetry service 320 may store telemetry data for a plurality of users of the content editing applications. In embodiments, telemetry data may be stored in association with user identification information which identifies the users to which the telemetry data pertains and may be used to access telemetry data pertaining to each user. In embodiments, the training data may be periodically updated as new user telemetry data is collected in which case the model training component may be configured to periodically retrain the shape prediction model to reflect the updates to the training data.

In response to receiving digital ink data, the shape prediction model 312 processes the digital ink data using rules learned during training to identify a candidate shape that is most likely being currently drawn in the canvas area. The candidate shape is then output as a shape prediction to the canvas component 310. The shape prediction may be provided to the canvas component as digital ink data representing an appropriately scaled and beautified version of the shape being drawn in the canvas area. The canvas component 310 can the present the complete shape represented by the shape prediction to the user, as discussed above. In embodiments, the shape prediction model 312 may be trained to provide shape predictions to the canvas component only when the score of a candidate shape exceeds a predetermined threshold value. This process can be used to prevent the display of shape predictions that are unlikely to be accepted by a user and therefore may interrupt the flow of work of a user.

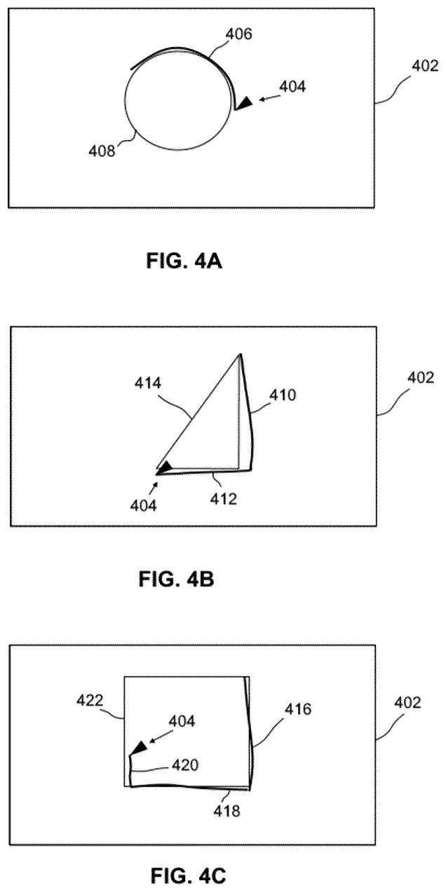

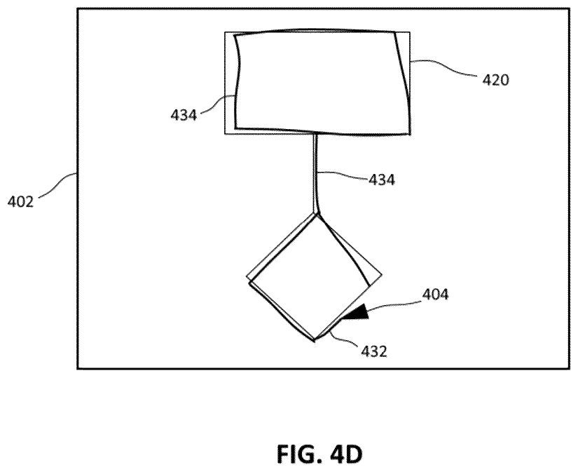

In embodiments, shape predictions are updated as more digital ink data is received. For example, the shape prediction model may generate an initial shape prediction based on initial digital ink data that has been received. The initial shape prediction may be presented to the user as discussed above. The shape prediction model 312 continues to process the digital ink data for the digital ink stroke as it is being received which may result in a new shape prediction of a different shape being drawn on the canvas. FIGS. 4B and 4C also show an example of how shape predictions may be updated as new digital ink data defining an unfinished shape is received. For example, in FIG. 4B, the shape prediction model 312 has predicted an initial complete shape 414, e.g., the right triangle, based on the digital ink data that has been received to that point. If the initial complete shape is not accepted, the shape prediction model 312 continues to receive digital ink data which extends the second line horizontally a bit farther and adds the beginning of a line extending vertically from the end. At this point, the shape prediction model 312 may predict that the shape being drawn is a square 422 as shown in FIG. 4C. The user may then accept the square as input at which point the digital ink strokes forming the incomplete square are deleted and replaced with the beautified square, or the user may continue to draw a shape without accepting the shape prediction.

The shape prediction model 312 may be trained initially to learn to predict a number of predetermined shapes. In embodiments, the shape prediction model 312 may be trained overtime to learn new shapes. New shapes may be added to the shape prediction model 312 in any suitable manner. In embodiments, the shape prediction model 312 and/or the canvas component 310 may be configured to identify closed shapes, e.g., shapes formed by digital ink strokes which for an enclosed area, for which no shape prediction has been generated and/or for which no shape prediction has been accepted by the user. The shape prediction model 312 and/or the canvas component 310 may be configured to generate a dialog or similar type of user interface control in the digital inking application indicating that a possible new shape has been detected and asking the user if the new shape should be added to the shape prediction model 312 for future predictions. In some embodiments, the system may be configured to identify unrecognized shapes as new shapes after the shape has been drawn a predetermined number of times. In either case, new shapes may be added to the shape prediction model by including the new shape in training data for the shape prediction model 312.

FIGS. 4A-4D show examples of different shape predictions that may be generated and displayed based on different digital ink stroke configurations. FIGS. 4A-4C each show a canvas area 402 of a display device for displaying digital ink strokes. Digital ink strokes are shown being drawn with reference to a drawing tool 404, which may be shown as a graphic in the canvas area or may correspond to the actual physical tip of a stylus or pen in the case of the display being a touch screen. The digital ink strokes of FIGS. 4A-4D are in the process of being drawn, and the drawing tool 404 shows the position of the extent to which the current digital ink stroke has reached at the time of a shape prediction.

FIG. 4A shows a digital ink stroke 406 having a curved path. In this example, the shape prediction component has predicted a complete shape 408 for the digital ink stroke 406 as a circle. The predicted shape 408, or circle in this case, is displayed in a different manner, e.g., with thinner lines in this case, than the digital ink stroke 406 so that the user can more easily identify the shape as a prediction provided by the system. FIG. 4B shows a partial shape formed by one or more digital ink strokes 410. The partial shape in this case includes a first line 410 that is arranged vertically and a second line 412 that extends generally perpendicularly from the bottom of the first line 410. In this case, the shape prediction component has predicted a complete shape 414 that is aright triangle. The right triangle 414 is displayed with thinner lines to differentiate from the digital ink 410, 412. FIG. 4C shows one or more digital ink strokes forming a first line 416 that is arranged vertically, a second line 418 that extends generally perpendicularly from the bottom of the first line 416, and a third line 420 that begins to extend vertically from the end of the second line 418. In this case, the shape prediction component has predicted a complete shape 422 that is a square. Similar to FIGS. 4A and 4B, the square 422 is displayed with thinner lines to differentiate from the digital ink 416, 418, 420.

In embodiments, the shape prediction component 304 may be trained to predict a number of different common, uncommon, simple, and/or complex shapes being drawn on the canvas As examples, the shape prediction component may be trained to predict many two-dimensional shapes, including round shapes, such as circles and ellipses, rectilinear shapes, such as square and rectangles, polygonal shapes, such as triangles, trapezoids, pentagons, hexagons, octagons, parallelograms, etc., other common shapes, such as hearts, stars, etc., as well as one-dimensional shapes, such as straight and curved lines, arrows, dotted lines, and the like. In embodiments, the shape prediction component 304 may be configured to predict uncommon shapes, such as rectilinear shapes with more than four sides (e.g., U-shaped, T-shaped, etc.) and partial-shapes (e.g., half-circle, quarter circle). In embodiments, predicted shapes may include only the boundary of the shape. In some embodiments, the shape prediction component may be trained to predict shapes with interior lines, such as grids, concentric rings, flattened three-dimensional shapes, etc.

In addition to regular and irregular shapes as described above, the shape prediction component may be trained to recognize shapes of simple and/or common objects being drawn on the canvas, such as clouds, flowers, simple animal shapes (e.g., fish, birds, cats, dogs, etc.) simple devices (e.g., phones, computers, etc.), simple vehicle shapes (e.g., cars, trucks, vans, etc.). Given the appropriate training data, the shape prediction component 304 may be trained to learn to recognize and predict substantially any shape.

The shape prediction component 304 may be trained to predict shapes based on other shapes that have been drawn in the canvas. For example, in embodiments, flowcharts and diagrams include common shapes, such as rectangles and diamonds, which are connected by lines and arrows. The shape prediction component may be trained to recognize one or more shapes or combinations of shapes which may be representative of a flowchart being drawn in which case the training of the shape prediction component can result in shapes common to flowcharts being more likely to be predicted. In embodiments, if a flowchart component is predicted, the predicted flowchart component may be depicted in combination with previously drawn flowchart components to present a beautified flowchart shape to the user for acceptance and incorporation into the document, such as shown in FIG. 4D which shows a combined predicted flowchart shape 430 based on the current digital ink stroke 432 and digital ink strokes 434 making up other shapes in the drawing.

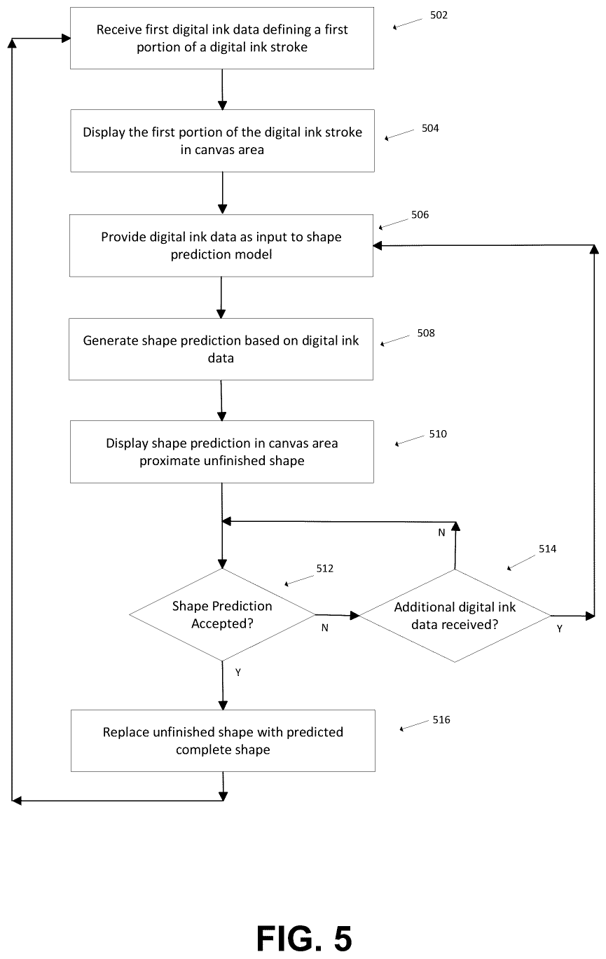

FIG. 5 shows a flowchart of an example method for generating shape predictions and incorporating shape predictions into a canvas as digital ink. The method begins with receiving first digital ink data that defines a first portion of a digital ink stroke (block 502). The first portion of the digital ink stroke is rendered and displayed in the canvas area of the digital inking application (block 504). The first digital ink data defining the first portion of the digital ink stroke is also provided as input to a shape prediction model (block 506). The shape prediction model processes the first digital ink data to generate a predicted complete shape being drawn in the canvas area (block 508). The predicted complete shape is displayed in the canvas area proximate the unfinished shape (block 510). The system then waits to receive input indicating acceptance of the shape prediction (block 512) or input in the form of additional digital ink data (block 514).

If input indicating acceptance of the shape prediction is received before additional digital ink data is received, the system deletes the digital ink stroke(s) forming the unfinished shape and replaces the unfinished shape with digital ink forming the predicted complete shape (block 516). If additional digital ink data is received before the predicted complete shape is accepted, control returns to block 506 where the additional digital ink data is provided as input to the shape prediction model which can generate another shape prediction (block 508). The shape prediction is displayed (block 510) awaiting further input (blocks 512, 514).

The detailed examples of systems, devices, and techniques described in connection with FIGS. 1-5 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-5 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

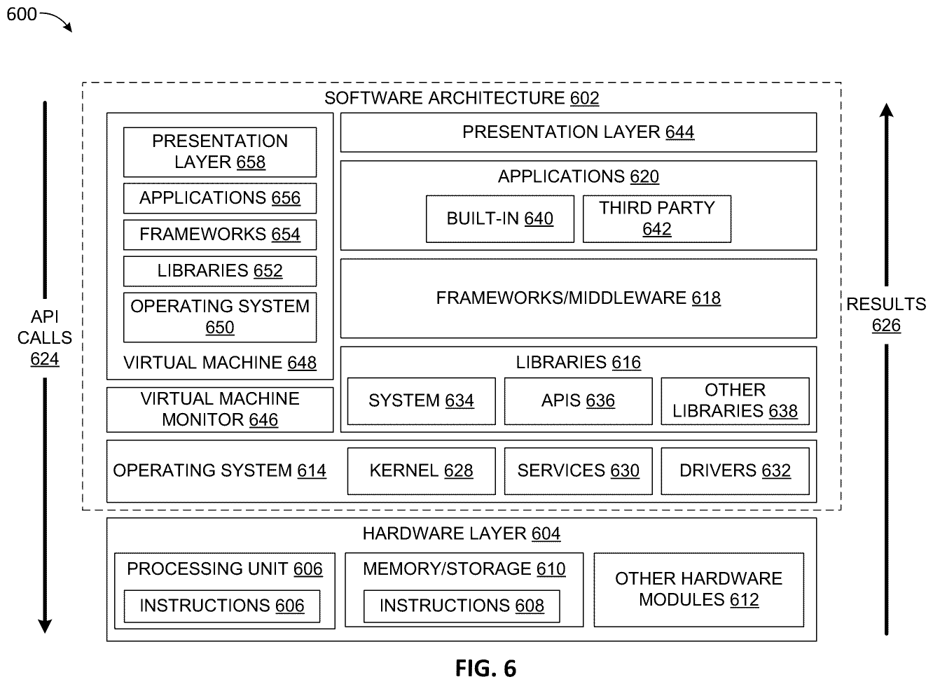

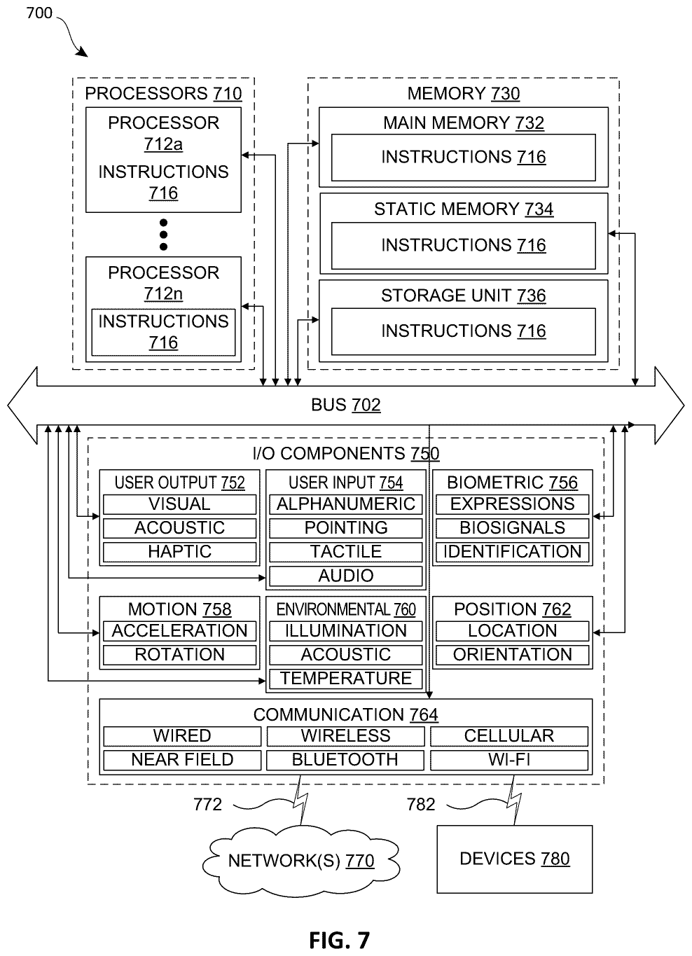

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via Internet Protocol (IP) address, location via Wi-Fi, cellular, NFC, Bluetooth, or other wireless station identification and/or signal triangulation.

In the following, further features, characteristics and advantages of the invention will be described by means of items:
Item 1. A data processing device comprising:
   a processor; and
   a memory in communication with the processor, the memory comprising executable instructions that, when executed by the processor, cause the data processing device to perform functions of:
   receiving a first input via a user input device corresponding to a first portion of a digital ink stroke;
   displaying the first portion of the digital ink stroke in a digital ink display area of an application on a display device, the first portion forming an unfinished shape;
   processing the first portion of the digital ink stroke using a shape prediction model to determine a first prediction of a complete shape being drawn in the digital ink display area;
   displaying the first prediction of the complete shape in the digital ink display area of the application proximate the unfinished shape;
   receiving a second input via the user input device indicating acceptance of the complete shape; and
   in response to receiving the second input, replacing the digital ink forming the unfinished shape with digital ink forming the complete shape.
Item 2. The data processing device of item 1, wherein the user input device includes a digitizer and a stylus.
Item 3. The data processing device of any of items 1-2, wherein the second input corresponds to moving the stylus away from the digitizer.
Item 4. The data processing device of any of items 1-3, wherein the second input corresponds to holding the user input device in place for a predetermined amount of time.
Item 5. The data processing device of any of items 1-4, wherein the functions further comprise:
   before receiving the second input, receiving a third input via the user input device corresponding to a second portion of the digital ink stroke;
   displaying the second portion of the digital ink stroke in the digital ink display area of the application on the display device, the second portion being part of the unfinished shape;
   processing the first portion and the second portion of the digital ink stroke using the shape prediction model to predict a second complete shape being drawn in the digital ink display area;
   in response to the second prediction being different than the first prediction; and
   replacing the first prediction of the complete shape with the second prediction of the complete shape in the digital ink display area of the application.
Item 6. The data processing device of any of items 1-5, wherein the complete shape is a beautified shape.
Item 7. The data processing device of any of items 1-6, further comprising:
   training the shape prediction model to score shape predictions based on a likelihood of a portion of a digital ink stroke corresponding to a particular shape, the shape prediction model being trained using training data including digital ink data representing a plurality of unfinished shapes correlated to completed shapes.
Item 8. The data processing device of any of items 1-7, wherein the training data is based on user telemetry data.
Item 9. The data processing device of any of items 1-8, further comprising:
   retraining the shape prediction model periodically with new training data as new user telemetry data is collected.
Item 10. The data processing device of any of items 1-9, wherein the shape prediction model processes the first portion in conjunction with previously drawn digital ink strokes to generate the first prediction.
Item 11. A method of processing digital ink in an application, the method comprising:
   training a shape prediction model to predict complete shapes based digital ink data defining unfinished shapes;
   receiving first digital ink data via a user input device defining a portion of a digital ink stroke;
   displaying the first digital ink data as digital ink in a digital ink display area of an application on a display device, the first digital ink data forming an unfinished shape;
   processing the first digital ink data using the shape prediction model to determine a first prediction of a complete shape being drawn in the digital ink display area;
   displaying the first prediction of the complete shape in the digital ink display area of the application proximate the unfinished shape;
   receiving a second input via the user input device indicating acceptance of the complete shape; and
   in response to receiving the second input, replacing the digital ink forming the unfinished shape with digital ink forming the complete shape.
Item 12. The method of item 11, further comprising:
   before receiving the second input, receiving a third input via the user input device corresponding to additional digital ink data;
   displaying the additional digital ink data as additional digital ink in the digital ink display area, the additional digital ink being part of the unfinished shape;
   processing the additional digital ink data and the first digital ink data using the shape prediction model to predict a second complete shape being drawn in the digital ink display area;
   in response to the second prediction being different than the first prediction; and
   replacing the first prediction of the complete shape with the second prediction of the complete shape in the digital ink display area of the application.
Item 13. The method of any of items 11-12, further comprising:
   training the shape prediction model to score shape predictions based on a likelihood of a portion of a digital ink stroke corresponding to a particular shape, the shape prediction model being trained using training data including digital ink data representing a plurality of unfinished shapes correlated to completed shapes.
Item 14. The method of any of items 11-13, wherein the training data is based on user telemetry data.
Item 15. The method of any of items 11-14, further comprising:
   retraining the shape prediction model periodically as new telemetry data is collected.
Item 16. The method of any of items 11-15, wherein the complete shape is a beautified shape.
Item 17. The method of any of items 11-16, wherein the user input device includes a digitizer and a stylus.
Item 18. The method of any of items 11-17, wherein the second input corresponds to moving the stylus away from the digitizer before the unfinished shape has been completed.
Item 19. A non-transitory computer readable medium on which are stored instructions that, when executed, cause a programmable device to perform functions of:
   receiving first digital ink data via a user input device defining a portion of a digital ink stroke;
   displaying the first digital ink data as digital ink in a digital ink display area of an application on a display device, the first digital ink data forming an unfinished shape;
   processing the first digital ink data using a shape prediction model to determine a first prediction of a complete shape being drawn in the digital ink display area;
   displaying the first prediction of the complete shape in the digital ink display area of the application proximate the unfinished shape;
   receiving a second input via the user input device indicating acceptance of the complete shape; and
   in response to receiving the second input, replacing the digital ink forming the unfinished shape with digital ink forming the complete shape.
Item 20. The non-transitory computer readable medium of item 19, wherein the functions further comprise:
   before receiving the second input, receiving a third input via the user input device corresponding to additional digital ink data;
   displaying the additional digital ink data as additional digital ink in the digital ink display area, the additional digital ink being part of the unfinished shape;
   processing the additional digital ink data and the first digital ink data using the shape prediction model to predict a second complete shape being drawn in the digital ink display area;
   in response to the second prediction being different than the first prediction; and
   replacing the first prediction of the complete shape with the second prediction of the complete shape in the digital ink display area of the application.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing device comprising:
a processor; and
a memory in communication with the processor, the memory comprising executable instructions that, when executed by the processor, cause the data processing device to perform functions of:
receiving a first input via a user input device corresponding to a first portion of a digital ink stroke;
displaying the first portion of the digital ink stroke in a digital ink display area of an application on a display device, the first portion forming an unfinished shape;
processing the first portion of the digital ink stroke using a shape prediction model to determine a first prediction of a complete shape being drawn in the digital ink display area;
displaying the first prediction of the complete shape in the digital ink display area of the application proximate the unfinished shape;
receiving a second input via the user input device indicating acceptance of the complete shape; and
in response to receiving the second input, replacing the digital ink forming the unfinished shape with digital ink forming the complete shape, wherein the shape prediction model processes the first portion in conjunction with other shapes that are currently displayed in the digital ink display area to generate the first prediction.

2. The data processing device of claim 1, wherein the user input device includes a digitizer and a stylus.

3. The data processing device of claim 2, wherein the second input corresponds to moving the stylus away from the digitizer.

4. The data processing device of claim 1, wherein the second input corresponds to holding the user input device in place for a predetermined amount of time.

5. The data processing device of claim 1, wherein the functions further comprise:
before receiving the second input, receiving a third input via the user input device corresponding to a second portion of the digital ink stroke;
displaying the second portion of the digital ink stroke in the digital ink display area of the application on the display device, the second portion being part of the unfinished shape;
processing the first portion and the second portion of the digital ink stroke using the shape prediction model to predict a second complete shape being drawn in the digital ink display area;
in response to the second prediction being different than the first prediction; and
replacing the first prediction of the complete shape with the second prediction of the complete shape in the digital ink display area of the application.

6. The data processing device of claim 1, wherein the complete shape is a smooth shape.

7. The data processing device of claim 1, further comprising:
training the shape prediction model to score shape predictions based on a likelihood of a portion of a digital ink stroke corresponding to a particular shape, the shape prediction model being trained using training data including digital ink data representing a plurality of unfinished shapes correlated to completed shapes.

8. The data processing device of claim 7, wherein the training data is based on user telemetry data.

9. The data processing device of claim 8, further comprising:
retraining the shape prediction model periodically with new training data as new user telemetry data is collected.

10. The data processing device of claim 1, wherein the shape prediction model processes the first portion in conjunction with previously drawn digital ink strokes to generate the first prediction.

11. A method of processing digital ink in an application, the method comprising:
training a shape prediction model to predict complete shapes based digital ink data defining unfinished shapes;
receiving first digital ink data via a user input device defining a portion of a digital ink stroke;
displaying the first digital ink data as digital ink in a digital ink display area of aft the application on a display device, the first digital ink data forming an unfinished shape;
processing the first digital ink data using the shape prediction model to determine a first prediction of a complete shape being drawn in the digital ink display area;
displaying the first prediction of the complete shape in the digital ink display area of the application proximate the unfinished shape;
receiving a second input via the user input device indicating acceptance of the complete shape; and
in response to receiving the second input, replacing the digital ink forming the unfinished shape with digital ink forming the complete shape, wherein the shape prediction model processes the first portion in conjunction with other shapes that are currently displayed in the digital ink display area to generate the first prediction.

12. The method of claim 11, further comprising:
before receiving the second input, receiving a third input via the user input device corresponding to additional digital ink data;
displaying the additional digital ink data as additional digital ink in the digital ink display area, the additional digital ink being part of the unfinished shape;
processing the additional digital ink data and the first digital ink data using the shape prediction model to predict a second complete shape being drawn in the digital ink display area;
in response to the second prediction being different than the first prediction; and
replacing the first prediction of the complete shape with the second prediction of the complete shape in the digital ink display area of the application.

13. The method of claim 11, further comprising:
training the shape prediction model to score shape predictions based on a likelihood of a portion of a digital ink stroke corresponding to a particular shape, the shape prediction model being trained using training data including digital ink data representing a plurality of unfinished shapes correlated to completed shapes.

14. The method of claim 13, wherein the training data is based on user telemetry data.

15. The method of claim 14, further comprising:
retraining the shape prediction model periodically as new telemetry data is collected.

16. The method of claim 11, wherein the complete shape is a smooth shape.

17. The method of claim 11, wherein the user input device includes a digitizer and a stylus.

18. The method of claim 17, wherein the second input corresponds to moving the stylus away from the digitizer before the unfinished shape has been completed.

19. A non-transitory computer readable medium on which are stored instructions that, when executed, cause a programmable device to perform functions of:
receiving first digital ink data via a user input device defining a portion of a digital ink stroke;
displaying the first digital ink data as digital ink in a digital ink display area of an application on a display device, the first digital ink data forming an unfinished shape;
processing the first digital ink data using a shape prediction model to determine a first prediction of a complete shape being drawn in the digital ink display area;
displaying the first prediction of the complete shape in the digital ink display area of the application proximate the unfinished shape;
receiving a second input via the user input device indicating acceptance of the complete shape; and
in response to receiving the second input, replacing the digital ink forming the unfinished shape with digital ink forming the complete shape, wherein the shape prediction model processes the first portion in conjunction with other shapes that are currently displayed in the digital ink display area to generate the first prediction.

20. The non-transitory computer readable medium of claim 19, wherein the functions further comprise:
before receiving the second input, receiving a third input via the user input device corresponding to additional digital ink data;
displaying the additional digital ink data as additional digital ink in the digital ink display area, the additional digital ink being part of the unfinished shape;
processing the additional digital ink data and the first digital ink data using the shape prediction model to predict a second complete shape being drawn in the digital ink display area;
in response to the second prediction being different than the first prediction; and
replacing the first prediction of the complete shape with the second prediction of the complete shape in the digital ink display area of the application.
